(19) United States
(12) Patent Application Publication
(10) Pub. No.: US 2018/0148944 A1
(43) Pub. Date: May 31, 2018

(54) Glory Hole Booth

(71) Applicant: Kenneth Mayle, Chicago, IL (US)

(72) Inventor: Kenneth Mayle, Chicago, IL (US)

(73) Assignee: Kenneth Mayle, Chicago, IL (US)

(21) Appl. No.: 15/364,272

(22) Filed: Nov. 30, 2016

(51) Int. Cl. E04H 1/12; E03D 11/16; E04H 3/10; H04N 5/225; H04R 1/10; F21S 8/00; H05B 33/08; A63G 31/00

(52) U.S. Cl. CPC E04H 1/125; E03D 11/16; E04H 3/10; H04N 5/2257; E03D 2201/00; F21S 8/033; H05B 33/086; A63G 31/00; H04R 1/1091

(57) ABSTRACT

The present subject matter describes a glory hole booth that comprises a chamber large enough to fit inside at least one adult human being, the chamber having a plurality of holes on at least one side-wall. The holes are for inserting a human body parts. The glory hole booth also has at least one set of lights fitted on an outer surface of side-walls of the chamber, preferably on the side-walls having the plurality of holes, wherein the set of lights is controllable by a control module.

### TECHNICAL FIELD

The subject matter of present disclosure relates to a glory hole booth for entertainment purposes.

### BACKGROUND OF THE INVENTION

Amongst the multitude of entertainment options available in the modem society, the rise of adult entertainment means has probably been the most spectacular. Modern stores are filled with adult entertainment options such as sex toys, games, adult music, etc, and such products enjoy a high demand throughout the world.

Among the adult entertainment options mentioned above glory hole related activities are probably the most favored by adults. A glory hole is a hole in a wall, or other partition often between public lavatory stalls or adult video arcade booths, for people to engage in sexual activity. Sometimes the use of a glory hole is to physically engage in sexual activities; however, sometimes glory holes are used to observe the person in the next cubicle. In either case varying levels of anonymity is part of the fetish.

In addition to traditional sexual organs such as a penis, other body parts like fingers or tongue may be inserted into the glory hole. However there is no limits to what really could be passed through the wall, potentially including entire appendages (hand/fists/arm/foot/leg), breast(s), sex toys, broom sticks, bowling pins, gas lines to perform enemas (liquid, flammable/non-flammable gas), sharp jabbing objects, electrocution leads, body fluids such as urine or spit, animals or animal products, foot long submarine sandwiches (food fetish), whispers/shouting/degrading words/complements, floor lamps, lumber, kink scene scripts, plans for space ships, newspapers, wrapped gifts, legal documents (consent), and so on just to name a small subset.

Glory holes over the ages have failed to evolve over the ages at the same rate as (by the moral majority opinion) morality of society diminishes. There seems to be a need for evolving design of modern day glory hole booth to keep adults pushing their limits allowing them to be slightly disgusted taper but still find a way to enjoy said extreme. Most glory holes available to adults are in locations that at times are too private or difficult for a large audience (including interaction with the audience) and do not also appeal to kinksters with exhibitionist fetishes. Also the typical glory hole in a dominant submissive relation only places power transfer between the two persons at the booth. However if the power transfer dynamic could be given to a third party a much different control on the kink scene as both parties at the booth effectively are submissive to an external dominant; somewhat a team of submissive is created at the booth; perhaps even induce humiliation emotions.

### SUMMARY

In accordance with a broad aspect of the present invention, the present subject matter describes a glory hole booth that can be used for a variety of adult entertainment purposes. The glory hole booth has a chamber large enough to fit inside at least one adult human being and having a plurality of holes on at least one wall of the chamber. The holes present on the walls of the chamber may be used for inserting items passed through walls of conventional glory holes as noted in the background section.

The glory hole booth also has at least one set of lights fitted on an outer surface of each wall on which holes are present. The set of lights is controlled by a control module. Each set of lights have multiple colored lights that switched on one at a time through the control module. The set of lights are indicative of the actions to be performed by players or participants who are present both inside and outside the chamber.

In an implementation, each participant could be fitted with electric collars that are a part of the glory hole booth itself The electric collars are used to give a mild electrical shock to the players. The electric collar may be controlled by the control module itself. In yet another implementation, the glory hole booth may have an audio module comprising of an audio player and at least one headphone that are provided for creating partial sensory deprivation for the players. The audio module may be controlled by or in communication with the control module.

In an implementation, there may be a hole provided on a top wall of the chamber. The hole may be used to mount a toilet having an outlet that empties into the hole leading to the inside of the chamber.

In another implementation, the glory hole booth may be accompanied by a ladder or a portable staircase to allow the participants get on top of the booth. The setup of the glory hole booth allows the players to use and play with it in multiple ways, as explained in the detailed description section.

It is to be understood that other aspects of the present invention will become readily apparent to those skilled in the art from the following detailed description, wherein various embodiments of the invention are shown and described by way of illustration. As will be realized, the invention is capable for other and different embodiments/implementations and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

A further, detailed description of the invention, briefly described above, will follow by reference to the following drawings of specific embodiments of the invention. These drawings depict only typical embodiments of the invention and are therefore not to be considered limiting of its scope. In the drawings:

FIG. 1 illustrates a preferred setup of a glory hole booth, in accordance with an implementation of the present subject matter.

FIG. 2 illustrates a method of utilizing the glory hole booth, in accordance with an implementation of the present subject matter.

### DETAILED DESCRIPTION

The description that follows, and the embodiments described therein, are provided by way of illustration of an example, or examples, of particular embodiments of the principles of various aspects of the present invention. These examples are provided for the purposes of explanation, and not of limitation, of those principles and of the invention in its various aspects. In the description, similar parts are marked throughout the specification and the drawings with the same respective reference numerals. The drawings are not necessarily to scale and in some instances proportions may have been exaggerated in order more clearly to depict certain features.

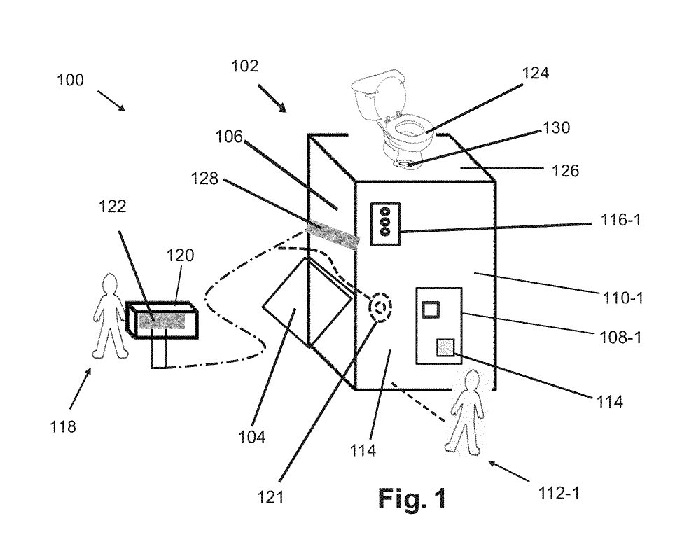

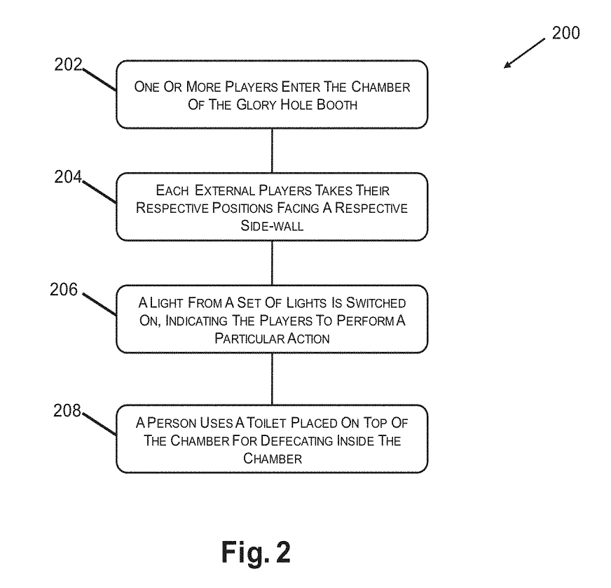

FIG. 1 illustrates a preferred setup of a glory hole booth 100, in accordance with an implementation of the present subject matter. The setup of the glory hole booth 100 described in the below description allows it to be used in various manners depending on the imagination of users. One of the many methods of using it has been described in FIG. 2 as explained later in the description.

The glory hole booth 100 includes a chamber 102 which is large enough to fit inside an adult human being. For comparison, the chamber 102 may be as large as, but not restricted to, a typical phone booth or a toilet stall. However, dimensions of the chamber may vary with number of players or participants using the glory hole booth 100. In an implementation, the chamber may be made up of materials like plywood, plastic, bamboo, cement. In an implementation, the base of the chamber may be square or rectangle in shape, even though other shapes are also possible.

The chamber 102 also has a door 104 which in an implementation is located at a side-wall 106 of the chamber 102 (even though the door 104 may be on any wall of the chamber 102). The door 104 allows one or more players using the glory hole booth 100 to enter inside the chamber 102.

The chamber 102 has a plurality of holes 108 on at least one of the side-walls for inserting various human body parts allowing the glory hole booth 100 to be used for adult entertainment purposes. For instance, each side wall other than side wall 106 may comprise a pair of holes as shown in FIG. 1. Thus, total number of holes that are to be present on any side-wall of the chamber 102 may be selected based on the number of players using the glory hole booth 100. For instance, the glory hole booth 100 depicted in FIG. 1 may be used at a time by six players, three inside and three external of the chamber 102. However, it is to be understood that other number of players is also possible.

For the implementation depicted in FIG. 1 there are a total of six holes, two for each of the side-wall 110-1, 110-2, 110-3 (sides 110-2 and 110-3 not visible in FIG. 1) and corresponding to an external player. The two holes provided for each player are hole pair 108-1, 108-2, and 108-3 corresponding to side-wall 110-1, 110-2, and 110-3 respectively (hole pairs 108-2 and 108-3 not visible in FIG. 1). Thus, hole pair 108-1, 108-2, and 108-3 correspond to a position of external player 112-1, 112-2, 112-3 respectively. Each hole pair includes two holes, an upper hole and a bottom hole.

The heights from ground at which the two holes are located are strategically selected. The upper hole corresponds to a height at which a mouth of the external player lies when the external player is on his/her knees. The bottom hole lies at a height slightly below waist of the external player when the external player is standing up. Each external player may use a chair or stool placed in front of each hole pair if desired by the external player. Alternatively, the upper hole may be used by the internal and external players to converse with each other. The conversation may allow the players to make dirty confessions to each other, like in a confessional booth usually located in churches.

In an implementation, each of the plurality of holes 108 has a sliding door 114 which can be opened or closed by any of the internal players or the external players for opening or closing the particular hole. It is to be noted that the sliding door 114 may not be restricted to a sliding type doors but may be also implemented by other door mechanisms, for instance, window type doors hingedly attached to a side of the particular hole.

Each hole pair has a corresponding set of lights 116 located on an outer surface of the side-wall on which the hole-pair is located. Each set of lights may have multi-colored lights, which can be switched on/off, usually one at a time, by an operator 118 (OR by remote operation as explained later). The switching on of a particular color of light is indicative of a particular action to be performed by the internal players or by the external players corresponding to the hole pair and the set of lights. For instance, set of lights 116-1, 116-2, and 116-3 correspond to hole pair 108-1, 108-2, and 108-3, respectively. Thus, when a particular colored light is switched on at the set of lights 116-1, external player 112-1 needs to perform a particular action corresponding to the particular color of light.

Alternatively, an automated sequence could also be programmed externally to create a desired sequence or pattern eliminating the need for an additional human to control the lights. More details about the use and significance of the lights will be described in the description pertaining to FIG. 2.

In an implementation, each light of the set of lights is an LED (light emitting diode). However, in other embodiments, the lights may be of other type as well. In the implementation depicted in FIG. 1, the lights, in each set of lights 116, are of three colors, namely red, green and yellow, even though the lights may be of any other color combination.

Since the set of lights 116 needs to be controlled by someone (i.e. an operator), the functioning of the set of lights can be controlled through a control module 120. The control module 120 is an electrical module connected to each of the set of lights 116 for allowing either of the operator/internal player to control the switching on/off of each light of the set of lights 116 or set an automated sequence for the same. For this the control module 120 has a simple circuitry comprising of at least a battery pack, wires, logic gates, all of which may be easily assembled by a person ordinarily skilled in the art.

In an implementation when control module is controlled by the operator 118, the operator may have the control module placed a few feet away from the chamber 102 in order to maintain anonymity. In order to control the set of lights 116, the operator may simply have to click relevant buttons present on a surface of the control module 120. Also, the internal players may also have access to an additional control module present inside the chamber 102, which allows him/her to control the set of lights. The additional control module may have an emergency switch 121 that can be pressed by an internal player. The emergency switch 121 is connected to control module 120. The pressing of the emergency switch 121 may result in a predefined action, for example, each of the set of lights display red light indicating all players to stop an ongoing game.

The control module 120 may also have a communication unit 122 coupled thereto for providing control of the control module 120 remotely to other users. For instance, the communication unit 122 may allow remote users located at far away locations to control the control module 120 through the internet or through their mobile phone network. For this, the communication unit 122 may have communication equipments such as GSM connectors, SIM card slots, processors, wireless routers (for wireless control), and the like.

The provision of the control module 120 allows addition of other units and capabilities to the glory hole booth 100. In an implementation, the glory hole booth may comprise an audio module 128 controllable by the control module 120. The audio module 128 may have a conventional audio player with speakers and headphones connected thereto. The speakers and the headphones provision the players to listen to audio messages sent by the operator (using the control module 120) or other messages sent by people over the internet (using the control module 120 and communication unit 122). The messages sent could be degrading, attempts to humiliate, praise, or other generally odd kinks like reading a newspaper to the intended player(s).

In addition, the glory hole booth 100 may also include a plurality of electric collars (not shown) that can be worn by each of the players. Each electric collar is a metal based collar that could be worn around neck, arms, legs etc. of the players. The electric collars are capable of providing a mild electric shock to the player wearing the same. The intent of the electric collars is to penalize (or perhaps reward if player a masochist) the participants for not following or for following directions given by the operator or other players. Each electric collar is connected to and controlled by the control unit 120.

Since the glory hole booth 100 is one of a kind, it has a special structure attached to it for providing an addition element of surprise and adventure to the players. The glory hole booth 100 has hole 130 on a top wall 126 of the chamber 102. A toilet 124 may be placed above the top wall 126 such that an outlet of the toilet opens inside the chamber 102 through the hole. Thus, the glory hole booth 100 allow another interesting punishment to be given to the internal players by making someone use the toilet 124 resulting in the waste product to fall on the internal player. In an implementation, the chamber 102 may have a staircase leading to the toilet 124 from ground for allowing someone to reach the toilet 124 from ground. The staircase may be a portable ladder for adding portability to the entire setup.

Also, video cameras may be placed both inside and outside the chamber 102 for capturing all the action in real-time. The video cameras may also interact with the communication unit 122 for streaming video feed captured by the camera online.

FIG. 2 illustrates a method 200 of utilizing the glory hole booth 100, in accordance with an implementation of the present subject matter. The method 200 allows the glory hole booth 100 to be used as an adult game played by multiple players. It is to be noted that the use of the glory hole booth 100 is not restricted to the below mentioned method blocks, but other methods may be improvised by the players. Also, the method 200 listed below is not restricted to the order in which they are presented below but the method steps may be performed in other orders as well without deviating from the spirit and scope of the present invention.

At block 202, one or more internal player enters the chamber 102 of the glory hole booth 100. The internal players are selected from a group of players who are willing to use the glory hole booth 100. The internal players may have volunteered themselves or may be chosen by the group of players. The internal players enter the chamber 102 through a door 104.

At block 204, the external players 112 take their respective positions facing the side-walls 110-1, 110-2, and 110-3 of the chamber 102. Each external player takes a position in front of a corresponding hole pair as explained earlier. In the implementation shown in FIG. 1 there are three hole pairs each having a corresponding set of lights.

At block 206, a particular light is switched on for each set of lights 116. In this example, the switching on of the particular colored light (yellow, green, and red) is done by an operator 118 who uses the control module 120 for controlling the operation of each set of lights 116. The color of the light switched on by the operator is indicative of an action to be performed by an external player corresponding to the set of light to which the switched on light belongs. The following list describes an action to be performed based on color of light:
a. When ‘Yellow’ colored light is switched on: The external player stands up in front of a corresponding hole pair and opens the bottom hole by moving sliding door. The external player then inserts his genital organ (penis) in the bottom hole of the hole pair. Any one of the internal players may then perform an activity consented upon by both parties. The activities may include rubbing, vigorously with hands, the genital organ of the external player, or putting the same in one's mouth.
b. When ‘Green’ colored light is switched on: The external player will lie on his knees so that his mouth corresponds to the position of the upper hole of the corresponding hole pair. He will then open the sliding door of the upper hole indicating the internal player to insert his genital organ through the open upper hole. The external player may then perform an activity consented upon by both the parties as explained above.
c. When ‘Red’ colored light is switched on: The external player and the internal player stop doing the activities they were involved in. The switching on or ‘RED’ light may also activate an electric collar worn by the external or internal player, thereby giving him a mild electric shock.

As mentioned earlier, there may be a sound played, by the speakers of the audio module whenever a new colored light is switched on, making the internal player and the outside player aware of the change. Note that during the duration of the mentioned activities, the players may be made to listen to messages from remote audiences or from the operator through headphones or speakers.

At block 208, a person may defecate inside the chamber 102 using the toilet 124. For this, the person, which may be one of the external players or may be chosen from the initial group of players, climbs the top of the chamber to reach the toilet 124. Note that act of defecation may be done at any point during the method 208 even though this act has been mentioned after block 206.

It may be noted that the defecation performed by the person is done by the consent of the internal players present within the chamber 102 as consent is extremely important in modern day society.

The act of defecation might be treated as a form of punishment for the internal players, which may be given by the group of players if the internal players do not meet set conditions. For instance, the internal players may be penalized for taking excessive time to perform activities indicated by the colored lights. Of course, the users of the glory hole booth 100 are free to improvise its use in the other innovative ways.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the appended claims.

I/We claim:

1. A glory hole booth comprising:
a chamber large enough to fit inside at least one adult human being, the chamber having a plurality of holes on at least one side-wall, wherein each of the plurality of holes is for inserting human body parts; and
at least one set of lights fitted on an outer surface of side-walls of the chamber, preferably on the side-walls having the plurality of holes, wherein each set of lights is controllable by a control module.

2. The glory hole booth of claim 1, wherein a top wall of the chamber comprises a hole.

3. The glory hole booth of claim 2, wherein a toilet is placed above the top wall of the chamber wherein a toilet outlet opens inside the chamber through the hole.

4. The glory hole booth of claim 1, wherein each hole of the plurality of holes comprises a sliding door coupled thereto for opening and closing the hole.

5. The glory hole booth of claim 1, wherein the chamber further comprises a door on one wall for allowing a human being to enter the chamber.

6. The glory hole booth of claim 1, wherein the control module comprises a communication unit that allows remote control of the control module.

7. The glory hole booth of claim 1 further comprising at least one electric collar controlled by the control module.

8. The glory hole booth of claim 1 further comprising video cameras placed inside and outside of the chamber.

9. The glory hole booth of claim 1 further comprising an audio module in communication with at least one headphone and controllable by the control module.

10. The glory hole booth of claim 1 further comprising a staircase for allowing a player to climb on top of the chamber.
